(19) United States
(12) Patent Application Publication
(10) Pub. No.: US 2016/0067821 A1
(43) Pub. Date: Mar. 10, 2016

(54) Process for Introducing a Weakening Line Through Material Removal on a Fibrous Coating Material, in Particular Natural Leather

(71) Applicant: JENOPTIK AUTOMATISIERUNGSTECHNIK GMBH, Jena (DE)

(72) Inventors: Walter LUTZE, Jena (DE); Juergen WEISSER, Jena (DE); Martin GRIEBEL, Jena (DE); Torsten REICHL, Jena (DE)

(73) Assignee: JENOPTIK Automatisierungstechnik GmbH, Jena (DE)

(21) Appl. No.: 14/786,644

(22) PCT Filed: Mar. 25, 2014
(86) PCT No.: PCT/EP2014/000805

§ 371 Date: Oct. 23, 2015

(30) Foreign Application Priority Data
Apr. 24, 2013 (DE) 10 2013 104 138.8

(51) Int. Cl. B23K 26/06; B23K 26/402; B23K 26/082; B23K 26/364

(52) U.S. Cl. CPC B23K 26/06; B23K 26/364; B23K 26/402; B23K 26/082

(57) ABSTRACT

Method for introducing a line of weakness through removal of material at a fibrous covering material, in particular a natural leather, in which a pulsed laser beam is guided a plurality of times over the back side in a line-shaped manner, wherein only one laser pulse is emitted for each impingement point, and the laser pulse causes an input of energy which leads to a heating of the fibrous covering material at the impingement point to a temperature above an ablation threshold and which maintains the temperature below a limit temperature in regions of the covering material adjoining the impingement point.

### RELATED APPLICATIONS

The present application is a U.S. National Stage application of International PCT Application No. PCT/EP2014/000805 filed on Mar. 25, 2014 which claims priority benefit of German Application No. DE 10 2013 104 138.8 filed on Apr. 24, 2013, the contents of each are incorporated by reference in their entirety.

### FIELD OF THE INVENTION

The invention is directed to a method for introducing a line of weakness through removal of material at a covering material as is known generically from Laid Open Application WO 2005/049261 A1.

### BACKGROUND OF THE INVENTION

In the present day, the use of airbag systems in vehicles or in means of transport is generally standard. The airbags are arranged as inconspicuously as possible behind parts of the interior trim of the vehicles so as not to infringe upon the aesthetic sensibility of passengers. The interior trim generally comprises stable, two-dimensionally extensive molded parts of plastic or composite materials. Since the airbags are ejected through the interior trim during a triggering event, airbag flaps must be provided. The airbag flaps are often formed by specially constructed areas of the interior trim having predetermined breaking points which are introduced along the edges of the airbag flaps and which ensure that the interior trim tears open reliably and in a defined manner.

In high-quality constructions of interior trim, the parts of the interior trim are often provided with additional, decorative covering materials through which the surfaces are visually and tactilely experienced. These covering materials are generally flexible, thin-walled materials such as plastic sheeting, imitation leather, textile knits, microfiber nonwovens or natural leather. For reliable deployment of the airbag, the covering materials must also be provided with predetermined breaking points in the area of the airbag flaps. For this purpose, lines of weakness are introduced in precisely the same manner as in the parts of the interior trim. For visual reasons, these lines of weakness are generally introduced from the back side of the covering material that is not visible. In addition to an exactly definable residual tear strength of the line of weakness, very high quality standards for the surfaces are only met when the line of weakness is not discernible visually or tactilely on the visible side of the covering material presented to the passenger.

There are a variety of methods available for introducing the lines of weakness. In a method described in Laid Open Application U.S. Pat. No. 5,082,310 A, the line of weakness is introduced with a knife-like blade. With the blade, the covering material is either scored on the back side or partial incisions are made on the back side about halfway into the material thickness. The covering material to be cut is described in the reference as a vinyl layer. The depth of the cut is adjusted by means of a mechanical supporting element which rests on the back side of the covering material, a distance of the blade from the mechanical supporting element being adapted to the material thickness.

The above-cited U.S. Pat. No. 5,082,310 A further discloses a controlled blade by which the depth of cut can be varied in the course of cutting.

The method is obviously well-suited to cut the vinyl layer described here, which has a constant material thickness. For natural covering materials such as leather which has inhomogeneities in the material thickness and material consistency, the principle of cutting depth adjustment is not suitable because there are no means provided for reacting to the inhomogeneities. On the whole, only a relatively small cutting depth can be used so that the visible side of the leather is not impaired at places where the material is thinner. However, at the relatively small cutting depth, the upper skin of the leather in which the tearing strength substantially resides and which is very thin remains fully intact.

German Patent DE 10 2006 054 592 B3 discloses a method in which weakened areas are introduced by laser in a decorative composite comprising layers. A decorative composite generally includes a decorative material on the visible side and a decorative material support, between which are arranged one or more layers of padding. The weakening is introduced in a plurality of successive operations. In a first operation, a non-penetrating pre-weakening of the decorative support is carried out and a post-weakening in the form of perforation holes penetrating the decorative support is carried out in the pre-weakened areas in at least one second operation. Between the pre-weakened areas or perforation holes, there remain unweakened bridges which are post-weakened in a second working step by means of at least one pocket hole. The above-cited publication does not provide specifics on the execution of the perforation holes or on adapting the perforation depth to inhomogeneous decorative materials such as leather, for example. Moreover, the method seems relatively complicated due to the quantity of different successive working steps.

A further laser method is described in the published DE 11 2006 000 443 T5. In this case, perforation holes are introduced into airbag covers, e.g., of instrument panels, by means of a pulsed laser beam. An instrument panel is formed of a base layer and a thinner skin layer (visible side) of plastic. The perforation holes are introduced from the base layer side and can extend into the skin layer. The depth of the perforation holes is adjusted through the monitored position of a focal point of the laser beam relative to the skin layer of the instrument panel. The spacing (referred to as “separation” in the reference) between the perforation holes is adjusted by varying the pulse repetition frequency (referred to as “cycle periods” in the reference). This publication also does not mention adapting the perforation depth to an inhomogeneous skin layer such as leather, for example.

A method in which the line of weakness is introduced in natural leather over a plurality of method steps is disclosed in Laid Open Application U.S. Pat. No. 5,611,564 A. First, the back side of the leather is pre-treated by saturating it in the area of the predetermined breaking point with a low-viscosity, hardening agent. The lacquer used for this purpose penetrates into the back side of the leather by up to 75% of the material thickness before hardening. The leather is embrittled in the area of the line of weakness by the cured lacquer which permanently remains in the leather. After embrittlement, the line of weakness is introduced into this area in the form of a notch or other kind of line-shaped recess. This is carried out through removal of material by means of laser methods or ultrasound methods by which the material thickness is reduced by a maximum 50%. In this method, there is no effort made to achieve a smallest possible residual wall thickness of the leather so that there is no risk of damaging the visible side of the leather at least when introducing the line of weakness. The intentional breaking effect in the area of the recess is achieved by embrittling the leather. However, the disadvantage of the embrittled area consists in the certainty that it will negatively affect the tactile characteristics on the visible side of the leather.

A method in which the line of weakness is produced by perforating a natural leather or other fibrous materials by means of a pulsed laser is disclosed in Laid Open Application WO 2005/049261 A1. The perforation is formed by a plurality of individual perforation holes which are arranged along the line of weakness so as to be separated by residual bridges.

As in the publications cited as prior art in the above-mentioned WO 2005/049261 A1, the line of weakness is introduced during a relative movement of the laser with respect to the covering material that is executed once, and perforation holes are made one at a time successively. The depth of the perforation is influenced and the remaining residual wall thickness of the covering material is adjusted, respectively, by correspondingly adapting the pulse duration and the laser power together with the speed of the relative movement.

Further, steps are suggested for minimizing the heat load on the covering material during laser machining. To this end, the perforation holes arranged consecutively on the line of weakness are produced by short and ultrashort laser pulses, respectively, with corresponding pauses between the individual laser pulses. In accordance with the disclosed method, it must be assumed that these pauses are achieved by reducing the pulse frequency so that the energy inputs of the laser pulses which otherwise impinge at higher frequency cannot add up over time.

To prevent changes in the fiber structure which lead to curling and, therefore, to visibility of the line of weakness, the covering material is either super-cooled or pre-shrunk before laser machining, or special fixing agents are applied to the back side.

As opposed to the methods mentioned above, a line of weakness with defined tear strength and appreciably reduced range of variation of the tear strength can be produced by this method. However, the fixation of the fibers prior to introducing the line of weakness necessitates at least one additional method step beyond the laser machining for applying the fixing agent. Moreover, the use of a fixing agent leads to an unwanted localized tactile alteration of the covering material on the visible side, particularly when the fixing agent is applied only to portions and not over a large surface. Further, the machining process is protracted owing to the pauses to be maintained between the laser pulses and the reduced pulse frequency of the laser for this purpose.

### OBJECTS OF THE INVENTION

It is the object of the invention to provide a method by which lines of weakness can be introduced in a fibrous covering material in a more economical manner by means of lasers without visual or tactile alteration of the visible side of the fibrous covering material.

According to the invention, for a method for introducing a defined line of weakness through removal of material at a fibrous covering material, particularly a natural leather, having a visible side and a back side opposite the visible side, in which a pulsed laser beam is directed to the back side and guided in a line-shaped manner, wherein the depth of a line of weakness that is formed in so doing is in part determined at impingement points of the laser beam along the line by a plurality of laser pulses, the above-stated object is met in that the line-shaped guiding is a multiple repetition of a scanning movement in which only one laser pulse is emitted for each impingement point along the line. The parameters of the laser pulse are selected such that this laser pulse causes an input of energy which leads at the respective impingement point to a heating of the covering material to a temperature above an ablation threshold, but the temperature is maintained below a limit temperature in regions of the covering material adjoining the respective impingement point.

The multiple repetition of the scanning movement is advantageously carried out until a minimum residual wall thickness is achieved on the visible side.

The fact that the scanning movement is repeated a plurality of times along the line in the same directional sense guarantees a cooling down period of identical duration for each location along the resulting line of weakness.

The speed of the scanning movement and the pulse repetition frequency of the pulsed laser beam are advantageously adapted to one another so that only one laser pulse impinges for each impingement point.

Alternatively, the laser beam can advantageously be switched on and off corresponding to a fixed regime during the repeated scanning movement so that the line of weakness introduced along the line has the form of a slit-bridge line with an alternating sequence of slits and bridges.

In an advantageous manner, the slits have a slit length in the range of from 2 to 5 mm and the bridges have a bridge length in the range of from one half to one fourth of the slit length.

It is advantageous when the laser pulses of the laser beam are generated by a short pulse laser having laser pulses with a length of from 1 to 10 ps which are emitted at a pulse repetition frequency of 10 to 100 kHz.

Alternatively, the laser pulses of the laser beam can advantageously be generated by an ultrashort pulse laser having laser pulses with a length of from 10 to 1000 fs which are emitted at a pulse repetition frequency of 10 to 100 kHz.

The monitoring of the minimum residual wall strength is advantageously carried out with a sensor which has a spatial resolution corresponding to the size of the impingement points.

It is advantageous when the laser beam is switched off in a spatially resolved manner during the scanning movement when the minimum permissible residual wall thickness (R) is reached at an individual impingement point.

### BRIEF DESCRIPTION OF THE DRAWINGS

The invention will be described more fully in the following with reference to embodiment examples. The accompanying drawings show:

FIG. 1 is the basic flow of the method with an arrangement suitable for this purpose; and

FIG. 2 is a section of the covering material with a portion of a completed line of weakness.

### DESCRIPTION OF THE EMBODIMENTS

A defined line of weakness 2 is produced by the method in a fibrous covering material 1. The fibrous covering material 1 can tear with a defined tear strength at the line of weakness 2. As used herein, fibrous covering material 1 is chiefly natural leather. The line of weakness 2 is introduced through removal of material by means of a pulsed laser beam 31. The line of weakness 2 is introduced on a back side 12 of the fibrous covering material 1 which faces away from the observer in the subsequent installed condition and, on a visible side 11 which faces the observer, is entirely invisible and indiscernible to touch.

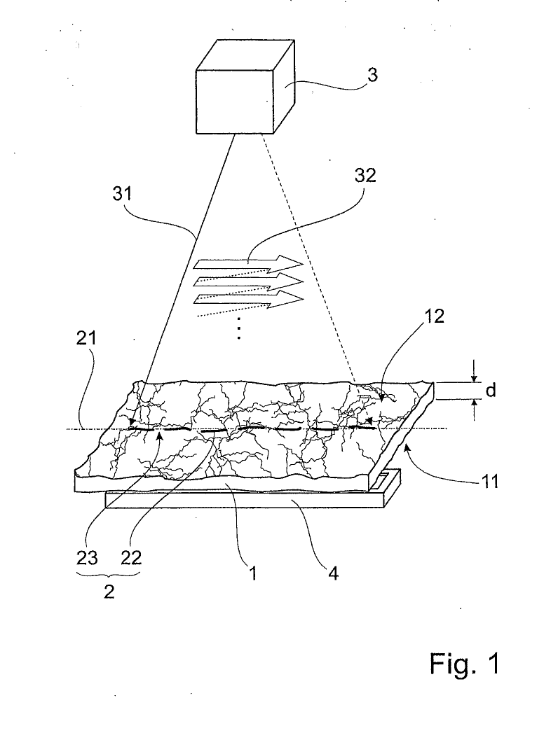

According to a first embodiment example shown in FIG. 1, a short pulse laser 3 is used to generate the pulsed laser beam 31, which short pulse laser 3 can emit laser pulses with pulse lengths of <10 ns and with pulse repetition frequencies in the range of from 10 kHz to 100 kHz. The pulse lengths can also be shorter and the pulse repetition frequencies can also be higher. The method is generally based on the use of the pulsed laser beam 31. In the following, it will be assumed that the laser beam, when designated as such, is always a pulsed laser beam 31.

The laser beam 31 which proceeds from the short pulse laser 3 and which is focused on the back side 12 of the fibrous covering material 1 is guided in a line-shaped manner along a line 21 by a relative movement. Consequently, the line of weakness 2 is introduced along this line 21.

Both the laser beam 31 and the fibrous covering material 1 can be moved for the relative movement along line 21. In principle, any means known from the prior art such as scanners (only for the laser beam 31), robots, linear drives, etc. can be used for this purpose. In this embodiment example, the relative movement is carried out by the laser beam 31 which is moved with a scanner.

As is known by the person skilled in the art, high pulse energies can be achieved with short pulse lasers 3. A high energy input is effected on a small surface and within a very short time at an impingement point 24 of the focused laser beam 31, as a result of which an ablation threshold in the covering material 1 is exceeded. Above the ablation threshold, a plasma is formed with each laser pulse such that the covering material 1 on which the laser pulse impinges evaporates explosively at the respective impingement point 24. The removal of material is effected by means of laser ablation, as it is called. The laser ablation proceeds at a speed such that only a very slight localized heating can occur at the impingement point 24 because no time remains for this localized heating to pass through heat conduction into areas of the fibrous covering material 1 directly adjoining the impingement point 24. Through appropriate adaptation of process parameters under which the short pulse laser 3 is operated, particularly a utilized laser power, the localized heating in the adjoining fibrous covering material 1 is always maintained below a limit temperature. If the limit temperature were exceeded, an alteration of the structure of the fibrous covering material 1 would occur in the areas adjoining the impingement point 24, as a result of which the line of weakness 2 would be noticeable on the visible side 11.

Therefore, it is key to the method that the energy input be selected in such a way that the temperature at the impingement point 24 exceeds the ablation threshold, while the temperature in the areas adjoining the impingement point 24 is kept below the limit temperature in order to introduce the line of weakness 2 into the fibrous covering material 1 without additional pre-treatment of the fibrous covering material 1 or other steps.

The line of weakness 2 can be configured in various ways. In this first embodiment example, it is formed of a series of slits 22 which are oriented in direction of the line of weakness 2 and separated from one another by a remaining bridge 23.

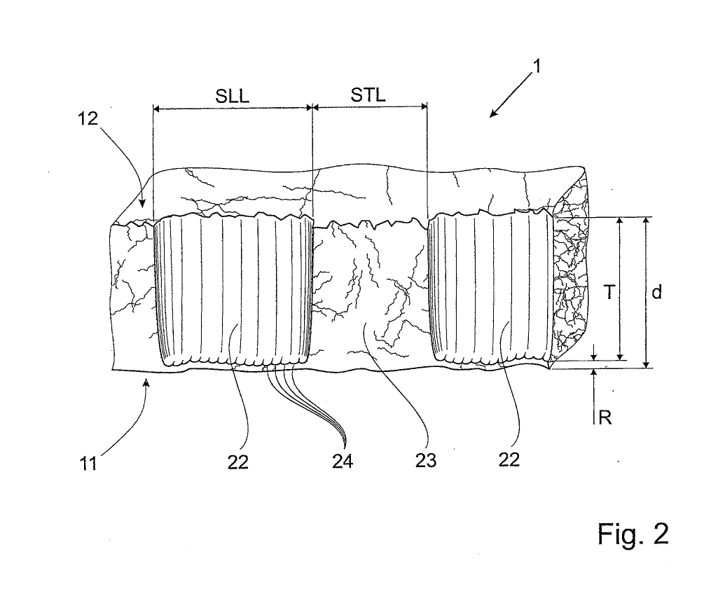

As is shown in FIG. 2, the removal of material takes place in the area of the slits 22 until a residual wall thickness R remains on the visible side 11. The slits 22 remain invisible on the visible side 11 because of the residual wall thickness R. The slits 22 and bridges 23 have a slit length SLL and a bridge length STL along the line of weakness 2 which are in the range of a few millimeters. The width of the slits 22 which is oriented at right angles thereto is determined by the focusing of the pulsed laser beam 31. With a conventional beam diameter in the beam focus of about 20 μm, the width of the slits 22 is approximately 30 μm.

The tear strength of the line of weakness 2 is adjusted via the residual wall thickness R of the covering material 1 in the area of the slits 22 and via the bridge length STL, this residual wall thickness R being adapted to the characteristics of the fibrous covering material 1. The bridge length STL is about one half to one fourth of the slit length SLL, and the slit lengths SLL are in the range of from 2 to 5 mm. Depending on requirements, other bridge lengths STL and slit lengths SLL can also be used.

When introducing the line of weakness 2 by means of the short pulse laser 3 operating in the kHz range at the ablation threshold, only very small amounts of the fibrous covering material 1 are removed superficially with each individual laser pulse. In the case of natural leather, the thickness of material removed during the one-time impingement of the laser beam 31 at the impingement point 24 is in the range of between 30 μm and 100 μm. Accordingly, depending on the material thickness d of the fibrous covering material 1, a plurality of laser pulses are required at the same impingement point 24 in order to reach a corresponding depth T of the line of weakness 2 and removal of material to the residual wall thickness R.

To this end, the pulsed laser beam 31 carries out a repeated, line-shaped scanning movement 32 relative to the fibrous covering material 1, which scanning movement 32 is faster compared to the relative movement in the prior art. Corresponding to the configuration of the line of weakness 2, the pulsed laser beam 31 is switched on and off in a fixed regime during the scanning movement 32 such that the series of slits 22 separated by bridges 23 results in the fibrous covering material 1 during the scanning movement 32.

Due to the fact that a further removal is not carried out at the same impingement point 24 until after a full scanning movement 32 has been completed, pauses occur during which the material can cool down. During the pauses at one impingement point 24, the removal of material takes place at other impingement points 24 so as to prevent a delay in the completion of the line of weakness 2 compared to the prior art.

In the area of the slits 22, the laser pulses emitted at pulse repetition frequencies of 100 kHz result in the removal of material. Corresponding to the pulse repetition frequency, the speed of the scanning movement 32 must be at least high enough that the impingement points 24 of two consecutive laser pulses are spatially separated such that only one laser pulse is emitted on each impingement point 24 during each scanning movement 32. The scanning movement 32 takes place at at least 200 mm/s assuming a 20-μm theoretical beam diameter of the focused laser beam 31.

Since the removal of material at the impingement point 24 with each laser pulse is only very slight, the line-shaped scanning movement 32 is repeated continuously. The repetitions are continued until the required residual wall thickness R is achieved in the area of the slits 22.

Therefore, it is key to the invention that the pulsed laser beam 31 carries out a continuous, frequently repeated scanning movement 32 relative to the fibrous covering material 1 at a sufficiently high speed.

When the line 21 along which the line of weakness 2 is to be introduced is a line segment, the first scanning movement 32 passes from one end of the line segment to the other end of the line segment. The first repetition of the scanning movement 32 starts again in the same directional sense at the end of the line segment at which the first scanning movement 32 also started. Between the repeating scanning movements 32, the switched-off laser beam 31 executes a return run between the two ends of the line segment.

During the scanning movement 32 which is repeated a plurality of times, the same pauses are achieved between the repeated impingements of the pulsed laser beam 31 at each impingement point 24. Therefore, the pause between two laser pulses at the same impingement point 24 is at least equal to the duration of a scanning movement 32 and a return run. It is noted here that it is neither envisaged nor required that the laser pulses impinge during every repeated scanning movement 32 exactly on the same impingement points 24 as the preceding scanning movement 32. However, to achieve a uniform removal of material, the speed of the scanning movement 32 is adapted to the pulse repetition frequency of the short pulse laser 3 in such a way that neither excessive overlapping nor excessively large gaps between adjacent impingement points 24 occur at the impingement points 24.

The scanning movement 32 could also take place with a constantly alternating direction in that the switched-on laser beam 31 is constantly guided back and forth between the ends of the line segment. In this case, however, the pauses between the laser pulses of the repeated scanning movement 32 would vary in duration in the vicinity of, and particularly directly at, the ends of the line of weakness 2 where the scanning movement 32 reverses. The pauses of different duration lead to a temperature level that increases toward the ends of the line of weakness 2 in the areas of the fibrous covering material 1 adjoining the impingement points 24 because the energy inputs can add up there. The limit temperature would quickly be exceeded as a result of the higher energy input, which would accordingly lead to changes in the structure of the fibrous covering material 1.

When the line 21 along which the line of weakness 2 is to be introduced is a closed contour, the repeated scanning movements 32 take place consecutively without interruption. The pause between two laser pulses at the same impingement point 24 is at least as long as the duration of a completed scanning movement 32.

The monitoring of the residual wall thickness R is carried out by a sensor 4 which is arranged opposite the short pulse laser 3 in direction of the laser beam 31 on the visible side 11 of the fibrous covering material 1. The sensor 4 continuously measures the intensity of a fraction of the laser pulse transmitting through the fibrous covering material 1 so that when the required minimum residual wall thickness R is achieved the laser beam 31 can still be switched off before completely passing through the fibrous covering material 1.

The entire line of weakness 2 is detected by the sensor 4 in a highly spatially resolved manner. The spatial resolution is at least high enough so that an individual impingement point 24 of the laser pulses can be localized. Accordingly, it is also possible to switch off the laser beam 31 in a spatially differentiated manner within the slit 22. If the minimum residual wall thickness R has already been reached at an impingement point 24, the laser beam 31 is switched off in a localized manner at this impingement point 24 during the next scanning movement 32. The removal of material continues unchanged in the rest of the slit 22. The scanning movements 32 are repeated as often as needed to achieve the required residual wall thickness R at each impingement point 24 in all of the slits 22 of the line of weakness 2. In this way, an optimal residual wall thickness R can be achieved in each individual slit 22 while taking into account all possible inhomogeneities in the fibrous covering material 1 and with spatial resolutions on the order of magnitude of the impingement points 24. In case of a fibrous covering material 1 made of common leather having a thickness of about 1 mm, about fifty scanning movements 32 are required for introducing the line of weakness 2.

In order to switch the short pulse laser 3 used for the method on and off in a spatially resolved manner, this short pulse laser 3 and the sensor 4 are connected via a closed control loop.

The method can be used in a particularly advantageous manner for weakening natural leather, but is not limited to this. It can be used advantageously for other flexible, inhomogeneous fibrous covering materials 1 such as felt or synthetic microfiber nonwoven.

In an advantageous embodiment of the method, picosecond lasers with laser pulse lengths of from 1 to 10 ps and pulse repetition frequencies of 10 to 100 kHz or femtosecond lasers with laser pulse lengths of from 10 to 1000 fs and pulse repetition frequencies of 10 to 100 kHz are used for generating the pulsed laser beam 31. The risk of thermal damage to the fibrous covering material 1 can be reduced to a minimum with these lasers.

In other embodiments of the method, sensors 4 other than those utilized for transmission measurement can also be used to determine the residual wall thickness R. In addition to detecting light, acoustic or thermal sensors 4 are also suitable, provided the signal detection is fast and sensitive enough to prevent the laser beam 31 from penetrating through the fibrous covering material 1.

A sensor array extending two-dimensionally over the entire course of the line of weakness 2 and a plurality of sensors 4 distributed over the course of the line of weakness 2 can both be used as sensor 4. A scanner which is guided along synchronous to the scanning movement 32 of the laser beam 31 and which supplies two-dimensionally acquired measurement signals to an individual sensor 4 can also be used.

In a further embodiment, the laser beam 31 is focused in a line shape rather than in a point shape. The line-shaped focus of the laser beam 31 accordingly also projects a line shape on the impingement point 24, the line shape is oriented in direction of the line of weakness 2 and so advantageously corresponds exactly to the slit length SLL. The removal of material carried out by the laser beam 31 takes place during a laser pulse over the entire slit length SLL. If the scanning movement 32 takes place synchronously with the regime of the line of weakness 2, every laser pulse of the current scanning movement 32 impinges on the same impingement point 24 as the preceding scanning movement 32. The residual wall thickness in the area of the slits 22 may be produced with a lower resolution compared to the point-focused laser beam 31, but the machining time is reduced because the scanning movement 32 can be accelerated.

In another embodiment, when introducing the line of weakness 2 the residual wall thickness R is minimized until the localized switching off of the laser beam 31 at one of the impingement points 24 takes place only when the laser pulses have penetrated through the visible side 11. The resulting holes are so small that they are on the order of magnitude of the pores which are naturally present in the leather and are accordingly also invisible on the visible side 11.

### LIST OF REFERENCE CHARACTERS

1 fibrous covering material

11 visible side

12 back side

d material thickness

R residual wall thickness

2 line of weakness

21 line

22 slit

23 bridge

24 impingement point

T depth (of the line of weakness)

SLL slit length

STL bridge length

3 short pulse laser

31 pulsed laser beam

32 scanning movement

4 sensor

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

what is claimed is:

1. Method for introducing a defined line of weakness through removal of material at a fibrous covering material having a visible side and a back side opposite the visible side, comprising directing a pulsed laser beam to the back side and guiding said laser beam in a line-shaped manner, wherein a depth of a line of weakness that is formed in so doing is in part determined at impingement points of the laser beam along a line by a plurality of laser pulses, said line-shaped guiding being a multiple repetition of a scanning movement in which only one laser pulse is emitted for each impingement point along the line, said laser pulse causing an input of energy which leads at the respective impingement point to a heating of the fibrous covering material to a temperature above an ablation threshold and which maintains in regions of the fibrous covering material adjoining the impingement point a temperature below a limit temperature that would result in changes in the structure of the fibrous covering material.

2. Method according to claim 1, wherein said multiple repetition of the scanning movement is carried out until a residual wall thickness is achieved on the visible side.

3. Method according to claim 1, further comprising repeating the scanning movement a plurality of times along the line in the same directional sense.

4. Method according to claim 1, further comprising adapting a speed of the scanning movement to a pulse repetition frequency of the pulsed laser beam so that only one laser pulse is emitted for each impingement point.

5. Method according to claim 1, further comprising switching the laser beam on and off corresponding to a fixed regime during the repeated scanning movement, wherein the line of weakness introduced along the line has the form of a slit-bridge line with an alternating sequence of slits and bridges.

6. Method according to claim 5, wherein said slits have a slit length in the range of from 2 to 5 mm and the bridges have a bridge length in the range of from one half to one fourth of the slit length.

7. Method according to claim 1, further comprising generating the laser pulses of the laser beam by a short pulse laser having laser pulses with a length of from 1 to 10 ps which are emitted at a pulse repetition frequency of 10 to 100 kHz.

8. Method according to claim 1, further comprising generating the laser pulses of the laser beam by an ultrashort pulse laser having laser pulses with a length of from 10 to 1000 fs which are emitted at a pulse repetition frequency of 10 to 100 kHz.

9. Method according to claim 2, wherein monitoring the residual wall strength is carried out with a sensor which has a spatial resolution corresponding to the size of the impingement points.

10. Method according to claim 9, wherein the laser beam is switched off in a spatially resolved manner during the scanning movement when the residual wall thickness is reached at an individual impingement point.
